(19) United States
(12) Patent Application Publication
(10) Pub. No.: US 2008/0111791 A1
(43) Pub. Date: May 15, 2008

(54) SELF-PROPELLED HAPTIC MOUSE SYSTEM

(76) Inventor: Alex Sasha Nikittin, San Jose, CA (US)

Correspondence Address: ALEX S. NIKITTIN, 797 APPLE TERRACE, SAN JOSE, CA, 95111, US

(21) Appl. No.: 11/560,351

(22) Filed: Nov. 15, 2006

(51) Int. Cl. G06F 3/033

(52) U.S. Cl. 345/163

(57) ABSTRACT

A haptic mouse system, comprising a self-propelled mouse (102) and a mouse pad (100), is intended for use as a mouse pointing device in a computer system. The haptic mouse system can provide directional force feedback to a user in response to commands from the host computer. The self-propelled mouse (102) is moveable over the mouse pad (100) and is separable therefrom, thus allowing the user to operate the device in multiple strokes like a regular mouse. The self-propelled mouse (102) includes a control circuit and a two-dimensionally driving motor having multiple drive elements. The motor can interact with the mouse pad (100) and produce a horizontal propelling force (106), perceptible to the user as a haptic feedback, when the drive elements are activated in a predetermined pattern and only when the self-propelled mouse (102) is placed on the mouse pad (100). The control circuit responds to commands from the host computer by varying the activation pattern in order to control direction and magnitude of the propelling force (106). Several preferred embodiments describe two-dimensionally driving motors of various design and principle of operation, including planar and spherical dynamoelectric motors, friction drives, and different types of vibration motors.

### BACKGROUND

1. Field of Invention

The present invention relates generally to haptic interface devices for use with a computer system, and more particularly to haptic mouse pointing devices.

In a variety of applications the computer system includes a central processing unit (CPU), a graphical user interface (GUI) to provide a user with a visual information, and a user-manipulable pointing device to input position change commands. The GUI usually includes a two-dimensional display that presents the user with a working environment in a graphical form and a cursor indicating the current position of the pointing device relative to this environment. The pointing device commonly has a manipulandum, mechanically moveable in two corresponding X-Y dimensions, and two position sensors that convert the motion into electric signals, further encoded into a stream of commands sent to the CPU. The CPU responds by changing the cursor position on the display, thus providing the user with visual feedback.

A haptic pointing device is simultaneously an input and output interface that, in addition to its pointing functionality, provides the user with haptic feedback in a form of mechanical force, applied to the manipulandum. Mechanical force can be applied to provide different tactile sensations like vibration, controlled resistance to movement, or controlled directional force. The latter is the most advanced method, especially practical when applied to a two-dimensional pointing device. A computer application employing a directional force feedback enabled pointing device can give the user a realistic perception of touching a three-dimensional object shown on the display. Varying feedback force in accordance with the cursor position, the application can make the object shape and texture tangible to the user as the cursor moves over the image.

Receiving complementary haptic feedback from the pointing device can give the user a more natural feeling of interaction with the objects displayed in the GUI. A computer interface having haptic capability in addition to traditional visual feedback is more convenient in operation and has better accessibility, for instance, for visually impaired users. Discussion of advantages and different methods of using haptic feedback in a computer interface can be found, among other sources, in U.S. Pat. No. 6,636,161 to Rosenberg.

A popular type of X-Y pointing device is a mouse system that can be either linked or separable. It includes a support base and a mouse manipulandum, moveable thereupon. The mouse system includes position sensors and associated circuitry, translating manipulandum movement into electrical signals that are being sent to the CPU.

In a linked mouse system, the manipulandum is attached to the support base with a lever mechanism. This design allows to place circuitry and a mechanical contraption of significant size and mass into the support base. However, the linked mouse system is restrictive in operation because movement of the cursor is always tracking the manipulandum that can not be disengaged from the base. As a result, the cursor coverage area on the GUI represents the working area of the manipulandum, and the device resolution is defined by their ratio.

In a separable mouse system, the manipulandum is a self-contained device that can slide over the mouse pad but is separate from it. In this context, the manipulandum is often referred to as a “mouse”. Position sensors and associated circuitry are located inside the mouse that connects to the CPU through a cable or wireless. Dependent on the sensors design, the mouse can be operated on a special mouse pad or any flat surface.

A very popular mouse that employs frictional coupling with the pad through a rolling ball is described in U.S. Pat. No. 3,987,685 to Opocensky. More advanced optical mouse systems, such as one described in U.S. Pat. No. 5,994,710 to Knee et al., can be more accurate but usually are more expensive.

As opposed to the linked mouse system mentioned above, the separable mouse can be operated in multiple strokes. When reaching the end of available working space, the user can lift the mouse above the pad and carry it over to a new position. When lifted, the mouse loses connection with the pad and stops sending position change commands to the CPU, causing the cursor on the GUI to stay in place. Thus, the cursor can be moved further with the next successive stroke. Because of this unique capability, the separable mouse system has practically unlimited coverage area, regardless of the pad size, and can operate at much higher resolution than that of the linked mouse system.

2. Description of Prior Art

Given the advantages discussed above, haptic pointing devices gain popularity in recent years. Several haptic joysticks and trackballs have been successfully developed and are already on the market. However, development of a viable haptic mouse system producing directional force feedback meets certain technical challenges.

For the haptic feedback to be perceived as realistic, its total loop time should be in the order of milliseconds. This includes signal processing time and reaction time of the mechanism producing the feedback force.

To reduce the signal processing time, it is advantageous to transmit only high level commands to and from the CPU and use a local microprocessor in the pointing device for data encoding and motor control. This approach has been pursued in several devices, such as a haptic trackball described in U.S. Pat. No. 6,876,891 to Shuler et al., and others.

Reducing the mechanism reaction time can be more difficult. The mechanical system usually includes a manipulandum itself, a motor or actuator, and some mechanical linkage in between. All of these parts have inertia, especially significant in case of a mouse device where the manipulandum is relatively large. Flexibility of the parts and play in the joints create a mechanical slack that requires more acceleration to overcome. Attempts to use more powerful motors or actuators further increase the system mass and prompt designers to place them in the supporting base, therefore limiting the application to linked mouse systems.

The linked mouse system with force feedback of U.S. Pat. No. 5,990,869 to Kubica et al. uses a scheme with the mouse manipulandum firmly attached to a plotter-like mechanical drive powered by two motors, with the whole assembly being mounted on the support base. This design allows applying force to the manipulandum in any direction defined by X and Y vectors along the drive rails, which simplifies the signal processing task. However, the device has all the limitations of a linked mouse system. The device resolution is fixed because the working area of the mechanism represents the entire display. Besides, excessive mass of the mechanical drive distorts the user tactile sensations. Furthermore, significant mechanical slack impairs reaction time of the system and causes perceptible jolt when the feedback force reverses direction.

The U.S. Pat. Nos. 6,100,874, 6,166,723, and 6,191,774, all to Schena et al., illustrate an effort to improve the mechanical drive performance in a similar scheme. These devices use a miniature pantograph or scissor mechanism to link the mouse manipulandum with the motors mounted in the base. The smaller mass and better rigidity of these mechanisms reduce mechanical slack and, therefore, allow for better quality haptic response. However, every one of these devices has the manipulandum mechanically attached to the support base, which prevents operation in multiple strokes.

A haptic mouse separable from its support base is described in the U.S. Pat. No. 6,717,573 to Shahoian et al. In this device, a miniature motor is mounted inside the mouse manipulandum and has a small eccentric mass attached to its shaft. When the motor rotates, the inertial disbalance causes the manipulandum to vibrate, which is used to provide tactile feedback to the user. While this device is an example of a separable haptic mouse system, its haptic capability is limited to only vibration and jolts.

The present invention is intended to introduce an advanced haptic mouse system that is both separable and capable of providing feedback in a form of directional force. This advantageous combination has not been achieved in any of the above discussed devices. The present invention offers a different from the prior art method to provide directional force feedback that can be used in a separable mouse system. The method relies on a two-dimensionally driving motor, located in the mouse manipulandum, to produce propelling force by interaction with the support base substantially on contact, which ensures separability of the mouse system. Several preferred embodiments described below employ planar and spherical motors of different types that are already known. While these motor types might be originally intended for use in other applications, reference to the known prior art is made, as appropriate, in the following sections.

### OBJECTS AND ADVANTAGES

The main objective of the present invention is to introduce a mouse system with haptic capability that combines the best of known mouse device types and haptic feedback methods. The preferred mouse device type of the present invention is the separable mouse system, and the preferred haptic feedback method is applying directional propelling force to the mouse manipulandum.

Other objectives of the present invention are to reduce inertia and mechanical play in the mouse drive system in order to improve speed and quality of the haptic feedback, to reduce power consumption, and to reduce the cost of the device.

The present invention is intended to identify and meet these objectives by disclosing a method and a general structure of the device that would be sufficient for those skilled in the art to design and build a working prototype. Several preferred embodiments, described below, employ alternative types of two-dimensional motor drives and offer various design trade-off choices for different implementations.

### SUMMARY—SCOPE AND RAMIFICATIONS

The present invention provides a mouse system with haptic capability in a form of directional force feedback. A device of the present invention is intended for use with a host computer having a CPU and GUI. The device includes a mouse and a mouse pad, separable from each other. The mouse is moveable over the mouse pad and has an internally mounted two-dimensional motor drive, a control circuit, and a position sensing device. The mouse can communicate with the CPU by sending commands indicative of its position change and receiving commands indicative of a desired feedback force direction and magnitude. The control circuit responds to the received commands by enacting the motor drive to propel the mouse in the desired direction on contact with the mouse pad. The propelling force can be perceived by a user as haptic feedback.

One group of preferred embodiments employs a two-dimensional planar motor having multiple drive elements that directly interact with the underlying mouse pad. In one embodiment, drive elements are electromagnetic coils and the mouse pad has a reaction plate that interacts with the coils by electromagnetic induction. In several other embodiments, continuously moving or vibrating drive elements interact with the pad surface by friction.

In another group of preferred embodiments, the mouse has a rolling ball as a part of a spherical motor. The spherical motor includes multiple drive elements that can interact with the ball, thus producing a torque. The ball serves as a medium between the drive elements and the mouse pad, translating the torque into propelling force on frictional contact with its surface. Several preferred embodiments employ dynamoelectric, friction, and vibration motor drive types.

For further understanding of the nature and advantages of the present invention, reference should be made to the following description in conjunction with the accompanying drawings.

### DRAWING FIGURES

FIGS. 1-A and 1-B are perspective views of a mouse device of the present invention being operated by a user in two consecutive phases of a stroke.

FIG. 2 is a schematic of a computer interface including the mouse device of FIGS. 1-A and 1-B.

FIG. 3 is an exploded view of an asynchronous induction planar motor, also showing a partial section revealing the internal structure of the support base in a first embodiment of the mouse device of FIGS. 1-A and 1-B.

FIG. 4 shows a bottom view of a stator assembly and a currents diagram to illustrate operation of the planar motor of FIG. 3.

FIG. 5 is an exploded view of a drive assembly in a second embodiment of the mouse device of FIGS. 1-A and 1-B including a plurality of friction wheels driven by a rotary motor.

FIG. 6 is an exploded view of a drive assembly in a third embodiment of the mouse device of FIGS. 1-A and 1-B including a brush member and a set of three vibration actuators.

FIG. 7 is a detailed sectional view illustrating operation of the drive assembly of FIG. 6.

FIG. 8 is a perspective view showing outline 800 of a piezoelectric motor fitting in the mouse body in forth, fifth, sixth, and seventh embodiments of the mouse device of FIGS. 1-A and 1-B.

FIG. 9 is a broken out exploded view of a travelling wave piezoelectric motor in the forth embodiment of the mouse device of FIGS. 1-A and 1-B.

FIG. 10 shows a detailed cross-section of the travelling wave motor of FIG. 9 to illustrate its operation.

FIG. 11 shows placement of crawling mechanisms 1100 in outline 800 of FIG. 8 in the fifth, sixth, and seventh embodiments of the mouse device of FIGS. 1-A and 1-B.

FIG. 12 is a diagram showing structure and operation of a two-element type of crawling mechanism 1100 of FIG. 11 in the fifth embodiment of the mouse device of FIGS. 1-A and 1-B.

FIG. 13 is a diagram showing structure and operation of a three-element type of crawling mechanism 1100 of FIG. 11 in the sixth embodiment of the mouse device of FIGS. 1-A and 1-B.

FIG. 14 is a diagram showing structure and operation of a four-element type of crawling mechanism 1100 of FIG. 11 in the seventh embodiment of the mouse device of FIGS. 1-A and 1-B.

FIG. 15 is an exploded view of a bottom shell assembly in an eighth embodiment of the mouse device of FIGS. 1-A and 1-B, including an asynchronous induction spherical motor and a ball.

FIG. 16 is a detailed partial sectional view across the ball and one stator of the spherical motor of FIG. 15, also showing a diagram of currents in the stator coils.

FIG. 17 is a detailed sectional view showing structure and operation of a vibrating brush spherical motor in a ninth embodiment of the mouse device of FIGS. 1-A and 1-B.

FIG. 18 is an exploded view of a drive assembly in a tenth embodiment of the mouse device of FIGS. 1-A and 1-B, including a plurality of friction wheels and a ball used as a drive medium.

### DETAILED DESCRIPTION OF PREFERRED EMBODIMENTS

The objective of the present invention is to add a directional force haptic feedback capability to a mouse system variety where the mouse has a built-in position sensing device and is separable from the mouse pad. Commonly, the mouse of this type has a plastic enclosure, constructed of top and bottom shells, which will be further referred to as a mouse body. The device of the present invention has a control circuit and a motor drive, both located in the mouse body; the mouse having this arrangement will be further referred to as a self-propelled mouse. To provide the haptic capability, the device of the present invention also includes a mouse pad of a complementary design, which enables the motor drive to produce propelling force on contact with it. The self-propelled mouse in combination with the complementary mouse pad will be further referred to as a self-propelled mouse system.

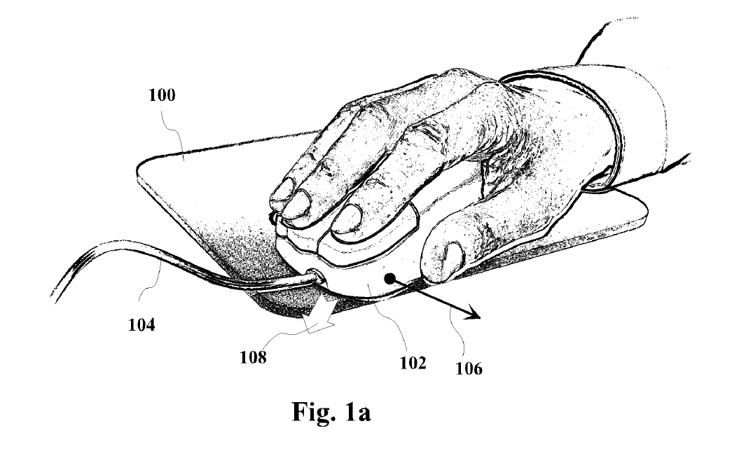

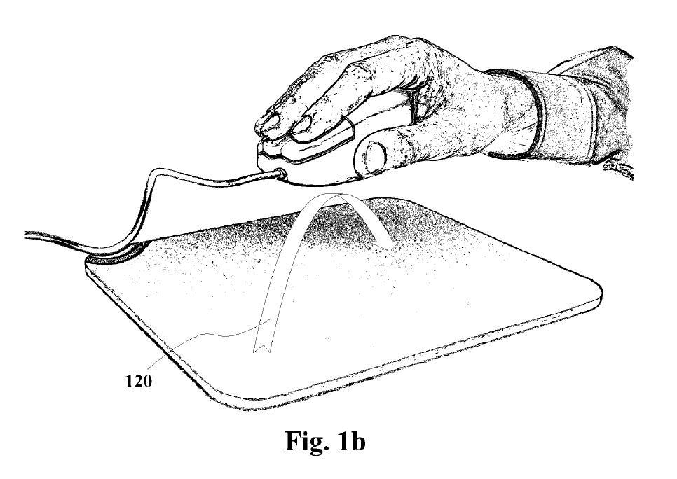

FIGS. 1-A and 1-B illustrate the advantageous capability of the self-propelled mouse system to be operated in multiple strokes. FIG. 1-A shows a self-propelled mouse 102 reaching the end of its working area on a mouse pad 100 while being moved in a direction 108 in a first stroke. During the stroke, the position sensing device sends out position change commands through a connecting cable 104. The position change commands tell a host computer to move a cursor on the GUI corresponding to direction 108. Concurrently, the control circuit receives commands from a host computer through cable 104 and causes the motor drive to produce a propelling force 106 perceptible to the user as haptic feedback. At the end of stroke, the user can carry over self-propelled mouse 102 to a new position, as shown in FIG. 1-B, and to continue moving it in direction 108 with the next stroke. Between the strokes, the user lifts the mouse body in an arc-like movement 120 that causes both the position sensing device and the motor drive to lose traction with mouse pad 100. As a result, both cursor control and haptic feedback are disabled between strokes.

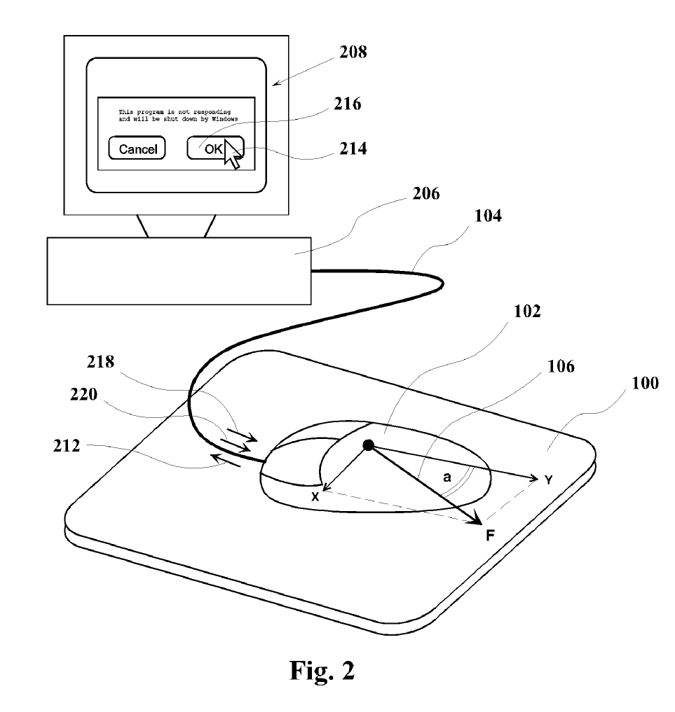

FIG. 2 shows a computer interface utilizing the haptic mouse system of the present invention. A CPU 206 receives position change commands 212 from self-propelled mouse 102 through connecting cable 104 and controls position of a cursor 214 in a GUI 208. Further, CPU 206 evaluates cursor 214 position against an adjacent object 216 displayed in GUI 208, calculates magnitude and direction of a desired feedback force for this situation, and sends feedback commands 220 to the control circuit in self-propelled mouse 102. Commands 220 can be encoded to characterize a vector of the desired feedback force in polar coordinates as a magnitude (F) and an azimuth (a), or in orthogonal coordinates as the vector projections (X) and (Y). The control circuit decodes feedback commands 220 and controls the motor drive to change propelling force 106 accordingly. CPU 206 also supplies self-propelled mouse 102 with electric power 218 required for operation of the motor drive and other circuitry.

Further described are several preferred embodiments of the haptic mouse system of the present invention, which differ by type and design of the motor drive. Some types of the motor drive require a complementary mouse pad of special design, while others will work with most conventional rubber mouse pads, laminated with fabric or plastic.

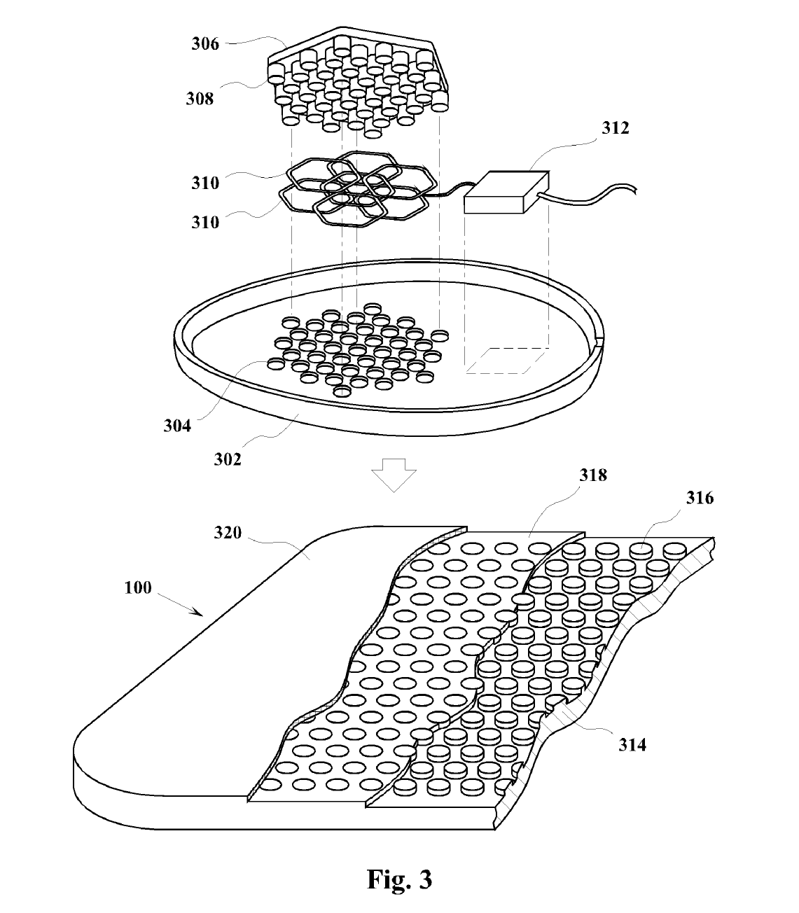

In the first embodiment, shown in FIG. 3, an asynchronous dynamoelectric planar motor is employed to produce the propelling force. A stator part of the motor and a control circuit 312 are assembled in a bottom shell 302 of the mouse body. The stator part comprises a ferromagnetic core 306 that has multiple poles 308 extending through openings 304 flush with a bottom plane of shell 302. The stator also has multiple coils 310 that are connected to control circuit 312 and encompass different groups of stator poles 308 distributed in two dimensions along the bottom plane of shell 302. In this embodiment, mouse pad 100 has a built-in reaction plate, comprising a ferromagnetic layer 314 overcoated with an electrically conductive layer 318. To improve performance, ferromagnetic layer 314 can have multiple reaction poles 316 protruding through openings in conductive layer 318. The whole structure is laminated with a top layer 320, made of textile or plastic, that serves to ensure smooth movement of self-propelled mouse 102 while maintaining a controlled magnetic gap and to provide compatible working surface for operation of the position sensing device.

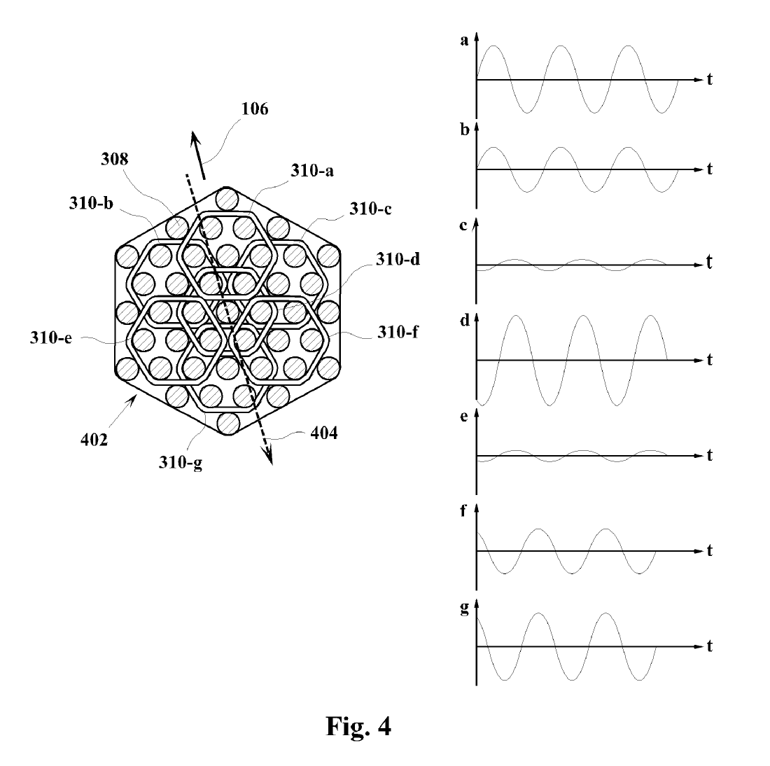

FIG. 4 shows a stator assembly 402 of planar motor of FIG. 3 and a diagram of electric currents (a) through (g) supplied to coils 310-a through 310-g by control circuit 312 of FIG. 3. In response to a received command, the control circuit determines a direction of driving force 404 that is opposite to the desired feedback force. Accordingly, the control circuit combines coils 310-a through 310-g into groups 310-(a,b), 310-(c,d,e), and 310-(f,g) and supplies each group with alternating currents having a phase ascending in direction 404. Alternating currents in coils 310 create a magnetic flux passing through stator poles 308. The control circuit controls amplitude balance between individual coils of each group to offset effective center of the flux produced by each group to further adjust driving force direction 404 and its magnitude. Due to the currents phase difference between the groups, magnetic flux moves from pole to pole across stator assembly 402 and forms a field of flux waves moving in direction 404. The moving magnetic flux closes through ferromagnetic layer 314 in the reaction plate of mouse pad 100 and excites eddy currents in conductive layer 318, which currents, in turn, create a counterbalancing magnetic field. Interaction between the moving magnetic flux and the counterbalancing magnetic field creates magnetic drag and ensuing electromotive force in direction 404. Reaction from mouse pad 100 produces propelling force 106 in the opposite direction.

Theory of operation of asynchronous motors in greater detail can be found in relevant special literature. Uni-dimensional linear motors of similar type are widely used in magnetic levitation transportation systems, such as one described in U.S. Pat. No. 3,967,561 to Schwarzler.

FIGS. 3 and 4 show stator assembly 402 having seven coils 310 and forty-three poles 308. It should be understood, however, that the present embodiment can not be limited to using this particular layout. Using greater number of coils 310 and poles 308 may be advantageous to decrease power required to produce sufficient propelling force 106.

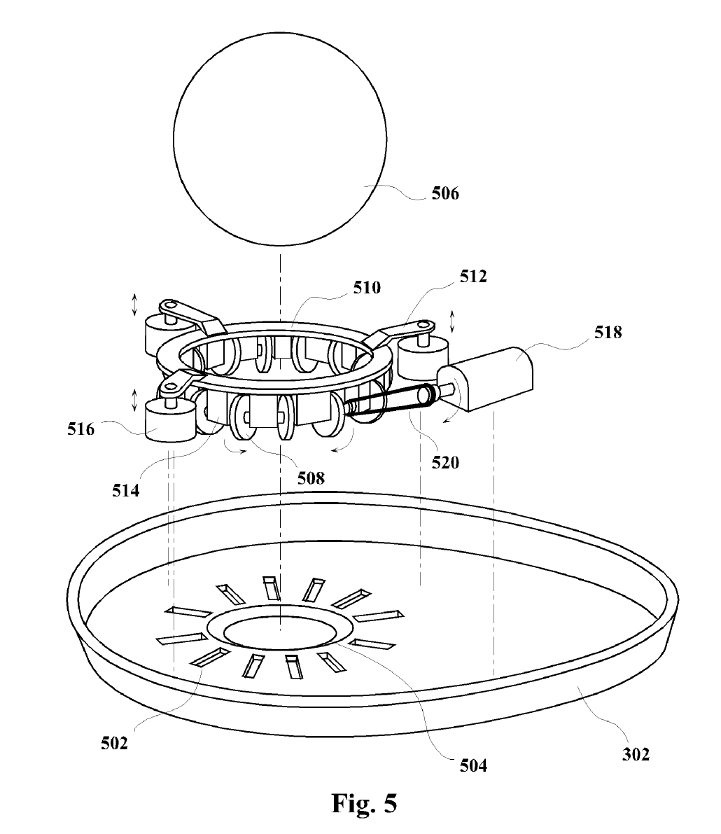

In the second embodiment, exemplified in FIG. 5, the planar motor drive employs friction of rotating wheels against mouse pad 100 to produce the desired propelling force. In this particular design example, friction wheels 508 are made as single pieces with their shafts and are mounted between bearings 514 on a circular frame 510. The shafts of the adjacent wheels 508 end with bevel gear teeth and rotationally couple together inside bearings 514. Frame 510 is suspended on three brackets 512, flexibly attached to electromagnetic actuators 516 which are secured to the bottom shell 302 that, in turn, has slots 502 matching position of wheels 508. One of wheels 508 is coupled with a rubber band and pulley gear 520 to a rotary motor 518 that is also secured in shell 302. This design can conveniently accommodate a rolling ball 506 that can pass unobstructed through the whole assembly and extend through an aperture 504. In this embodiment, rolling ball 506 can be used to drive X-Y position encoders similar to the device of U.S. Pat. No. 3,987,685.

During operation of planar motor drive of FIG. 5, rotary motor 518 is continuously powered and causes all friction wheels 508 to rotate in their respective directions. When no force feedback is required, electromagnetic actuators 516 are disabled and wheels 508 are suspended in slots 502 short of reaching the bottom surface. To create a propelling force in response to the received command, the control circuit differentially energizes actuators 516 such as to force down the side of frame 510 where friction wheels 508 rotate in the desired direction. The rotating wheels reach out through slots 502 and rub on the underlying mouse pad surface, producing propelling force by friction. More power in actuators results in more friction and higher propelling force.

Obviously, modifications can be made to this design in different parts material, shapes, number, and combination thereof. Alternatively, brush wheels, rather than solid disks, can be used as friction wheels for better control of propelling force. Other types of wheel-to-wheel and wheel-to-motor coupling can be employed. It should be understood that this embodiment is not limited by a particular design example shown in FIG. 5 and these modifications are allowed within the scope of the present invention as set forth in the claims below.

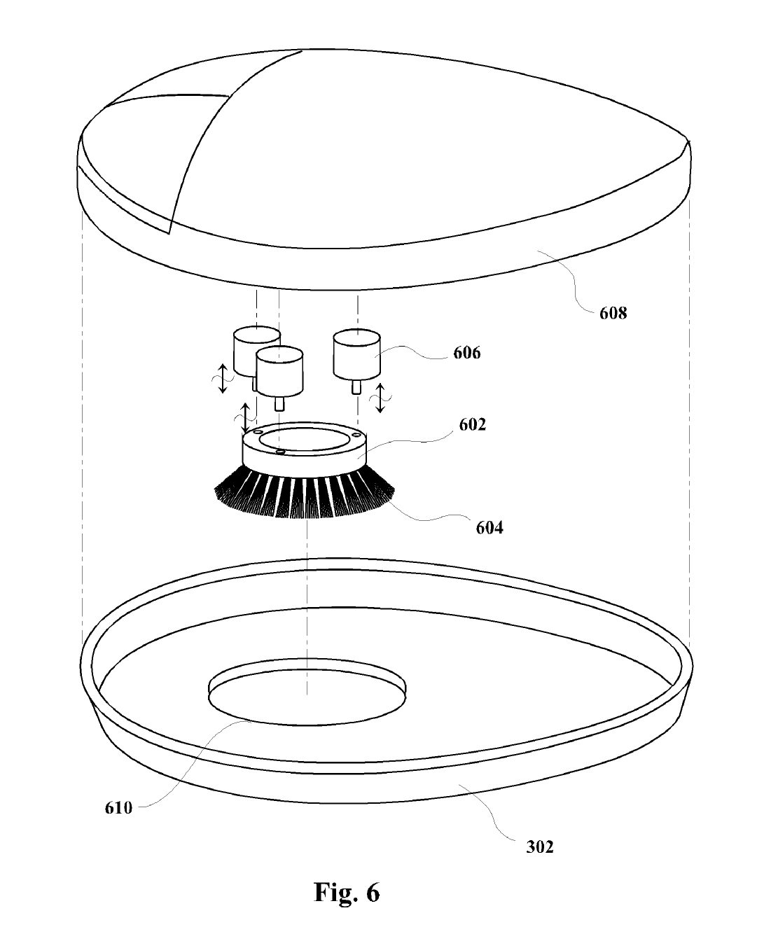

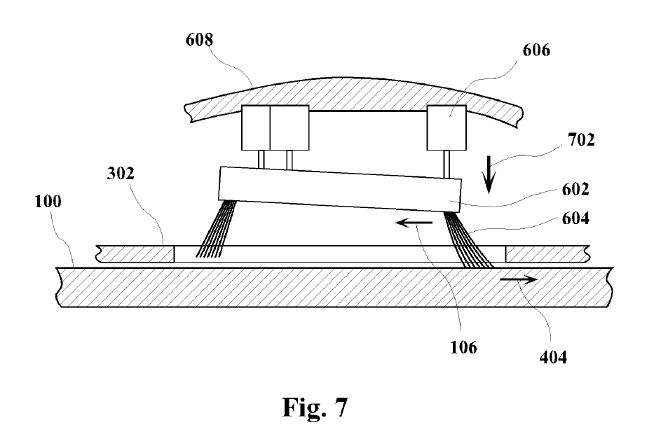

FIGS. 6 and 7 illustrate the third embodiment of the present invention, where the motor drive includes a vibrating brush. The brush has a circular frame 602 and multiple bristles 604 that are radially slanted. The brush is mounted with flexible joints on three electromagnetic actuators 606 which are secured in a top shell 608 of the mouse body. The height of the assembly is adjusted such as bristles 604 of the brush are exposed through an aperture 610 in bottom shell 302 short of touching the underlying surface of mouse pad 100 which is textured to impede horizontal slippage of bristles 604. The control circuit applies power to actuators 606 in a form of repetitive electric pulses of variable amplitude, causing the brush to vibrate. In response to the received command, the control circuit changes power balance between actuators 606 such as to cause most intensive vibration on the brush side where bristles 604 are slanted in the desired direction. The vibrating bristles repetitively strike the surface of underlying mouse pad 100 and flex in a direction of their slant, translating vibration energy into horizontal impulses of force in direction 404 that, in turn, cause reactive force from mouse pad 100 in the opposite direction. Due to inertia in the system, the repetitive impulses cumulate and result in desired propelling force 106.

Vibrating brush motor of FIGS. 6 and 7 can be classified as a pawl-and-ratchet motor where bristles 604 act as pawls, and mouse pad 100, having textured surface, serves as a two-dimensional planar ratchet. Alternatively, the brush can be vibrated horizontally while being simultaneously pushed down to increase traction in the area where bristles 604 have the desired slant; several differently oriented brushes, each having unidirectionally slanted bristles, can be used; more design modifications are also possible. A vibration motor, employing a similar mechanical principle of operation, but having a pawl shaped as a sharp-edged plate rather than a brush, is described in U.S. Pat. No. 4,019,073 to Vishnevsky et al.

For the present invention application, the motor drive needs to be compact and capable to provide relatively high propelling force while having low inertia. However, the device does not have to either travel a great length or accelerate to high speed. A new generation of piezoelectric crawling motors offers an attractive combination of properties to suit this particular application. Availability of new materials like piezoelectric polymers makes this type of motors even more practical.

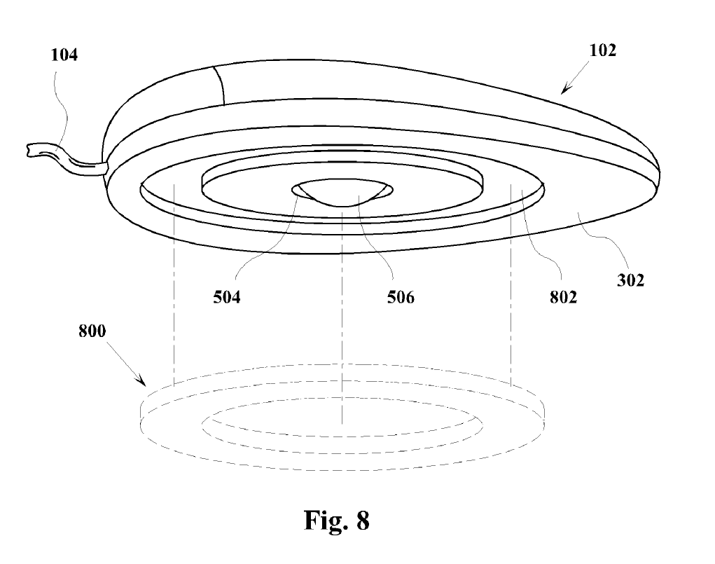

FIG. 8 shows a general design layout for self-propelled mouse 102 to incorporate a piezoelectric crawling motor in the forth, fifth, sixth, and seventh embodiments of the present invention. The mouse body contains the control circuit and other components, such as X-Y position encoders and associated circuitry that receive power and communicate with a host computer through cable 104. The crawling motor has an outline 800 and is assembled in a cutout 802 in bottom shell 302 of the mouse body. This design exemplifies a convenient option where cutout 802 is shaped as a ring to accommodate mouse ball 506 that extends through aperture 504 and can be used to drive X-Y position encoders.

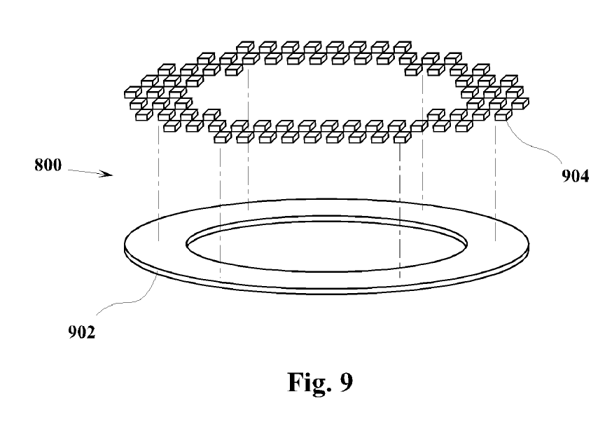

FIGS. 9 through 14 show several crawling mechanism types that can be used to construct the motor of FIG. 8 in outline 800. Crawling mechanisms described here have a common structure characterized in a group of piezoelectric elements being mechanically coupled to a friction member that spans their working ends. Piezoelectric elements are attached to bottom shell 302 and electrically connected to the control circuit, and the friction member is exposed on the bottom of self-propelled mouse 102 to enable a friction contact with the underlying surface.

One known type of the piezoelectric crawling motor is a travelling wave motor, such as one of rotational type used in camera lens focusing systems, described in U.S. Pat. No. 4,484,099 to Kawai et al. In its original embodiment, this motor operates at ultrasonic frequency and requires hard support surface and significant compressing force in order to operate. Another travelling wave motor of U.S. Pat. No. 4,736,129 to Endo et al. uses an elastic layer as a resonant body to excite travelling waves of greater amplitude. This type of motor can work on softer support surfaces. It is possible to further modify this design such as to meet the present invention application demands.

In the fourth embodiment of the present invention, a similar type of a travelling wave motor having an elastic layer is used to provide a two-dimensional planar drive. FIG. 9 shows an assembly structure of a planar motor in this embodiment. The planar motor of FIG. 9 includes an array of piezoelectric elements 904 electrically connected to the control circuit and attached to bottom shell 302. The array is ring-shaped to fit outline 800. An elastic layer 902 is bonded to working ends of piezoelectric elements 904 facing the bottom of the assembly.

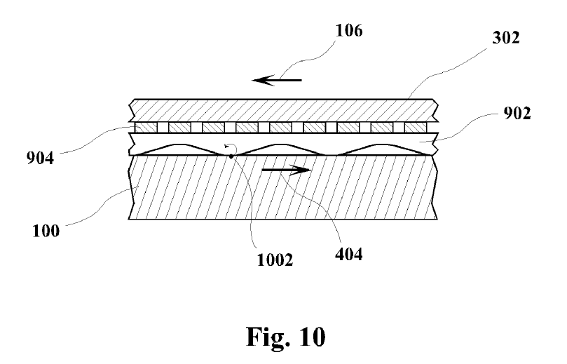

FIG. 10 illustrates operation of the planar motor of FIG. 9. The control circuit excites piezoelectric elements 904 with alternating voltages, having frequency and phase difference such as to produce travelling waves in elastic layer 902. Phase pattern is selected to produce travelling waves, propagating across the array in direction 404 of the desired driving force. Wavefront zones on the surface of elastic layer 902 move by a circular trajectory 1002 in a plane normal to the wavefront. When the mouse is brought in contact with the surface of mouse pad 100, moving wavefront zones of elastic layer 902 have friction at the lower point in trajectory 1002 and produce driving force in direction 404. Ensuing reaction from mouse pad 100 produces propelling force 106 in the opposite direction.

It should be noted that, unlike in rotational motors of U.S. Pat. Nos. 4,484,099 and 4,736,129, travelling waves propagation path in the planar motor of FIG. 9 is linear rather than circular.

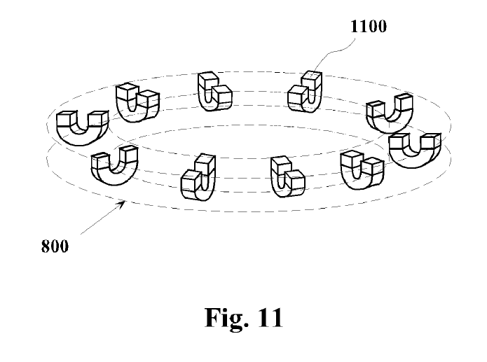

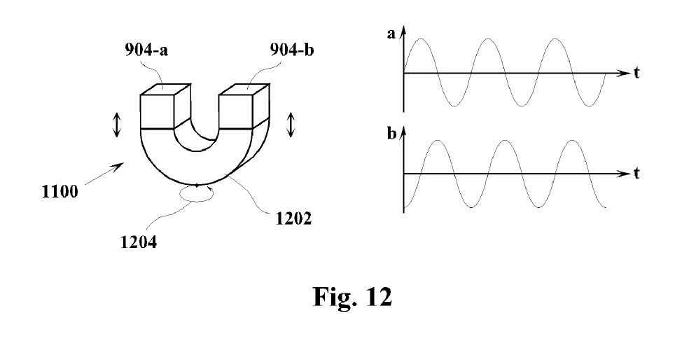

In the fifth embodiment, illustrated in FIGS. 11 and 12, piezoelectric elements 904 of the crawling planar motor are arranged in pairs, having their working ends bound to a flexible friction member 1202. In this arrangement, each pair makes an individual crawling mechanism 1100, which can act in two directions along the pair common axis. The crawling planar motor shown in FIG. 11 contains ten crawling mechanisms 1100, radially oriented within ring-shaped outline 800; other orientation arrangements are also possible.

Operation of crawling mechanism 1100 can be understood from FIG. 12. Two piezoelectric elements 904-a and 904-b are cyclically excited with alternating voltages (a) and (b), having phase difference of 90 degrees. Resulting mechanical action of the elements is applied at the ends of friction member 1202, causing its middle point to move in a vertical plane by an elliptical trajectory 1204 and to rub on the underlying surface with increased pressure during the lower half-cycle. Friction force produces a horizontal propelling impulse in a direction, determined by orientation of crawling mechanism 1100 and the phase order of voltages (a) and (b).

A V-shaped mechanism of a rotational motor described in U.S. Pat. No. 4,339,682 to Toda et al. uses a similar principle of operation and can be brought as another example to better understand the process.

The control circuit in the planar motor of FIG. 11 activates only a selected group of crawling mechanisms 1100 that are oriented primarily along the desired feedback force direction. The activated group automatically gains more traction because friction members 1202 of this group extend down during cycles. Operating at ultrasonic frequency makes individual propelling impulses imperceptible to the user, cumulating into substantially continuous propelling force. Alternatively, to improve continuity of the propelling force, crawling mechanisms 1100 of FIG. 12 can be further organized in two or more interlaced sub-groups powered in consecutive phases.

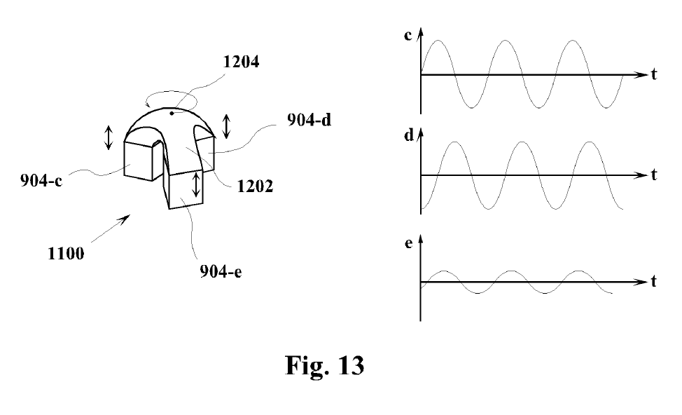

FIG. 13 illustrates structure and operation of a three-element crawling mechanism in the sixth embodiment of the present invention. Its design is similar to that of FIG. 12 except that friction member 1202 resides on three piezoelectric elements 904 rather than two. For clarity, three-element crawling mechanism 1100 is shown in FIG. 13 upside down, with its friction member 1202 oriented upwards. Three piezoelectric elements 904-c, 904-d, and 904-e are distributed in horizontal plane and excited with alternating voltages (c), (d), and (e) that cause working ends of the elements to vibrate. The control circuit balances phases and amplitudes of voltages (c), (d), and (e) such as to move the apex point of friction member 1202 by elliptic trajectory 1204 in a vertical plane, oriented in the desired direction. Thereby, each three-element crawling mechanism 1100 of FIG. 13 can serve as a two-dimensional drive. In a motor drive assembly of FIG. 8, all crawling mechanisms of this type are oriented alike and act simultaneously, having their respective piezoelectric elements powered in parallel. Same as with the planar motor of FIG. 12, crawling mechanisms 1100 of FIG. 13 can be organized in two or more interlaced groups powered in consecutive phases.

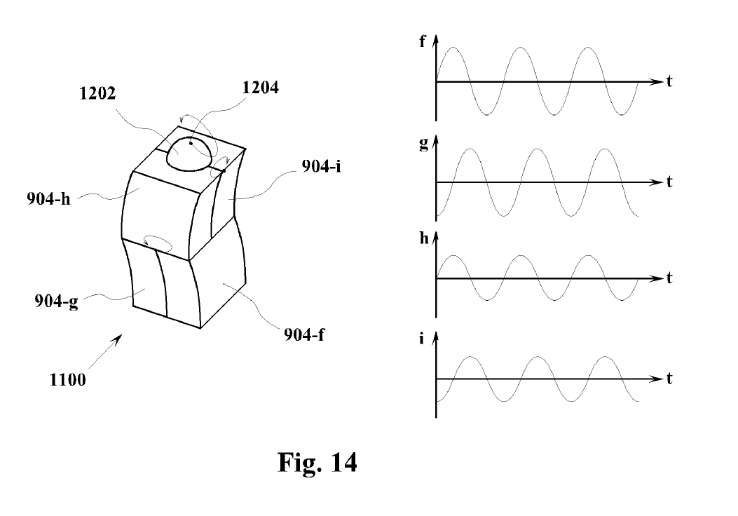

In the seventh embodiment, a four-element crawling mechanism is constructed by stacking up mutually orthogonally two pairs of piezoelectric elements, as shown in FIG. 14. Same as in the previous drawing, crawling mechanism 1100 in FIG. 14 is shown upside down for clarity. The bottom pair 904-f, g is secured to the mouse body, and friction member 1202 is attached to the top pair 904-i, h. Each pair of elements 904-f, g and 904-h, i is excited with a 90 degrees phase-shifted voltages (f, g) and (h, i). Amplitudes of voltages, applied to each pair, determine X and Y components of the propelling force that results from friction of the apex point of friction member 1202, moving by elliptical trajectory 1204, against the underlying surface. A single four-element crawling mechanism 1100 of FIG. 14 has a two-dimensional drive capability, same as the three-element crawling mechanism of FIG. 13. Multiple crawling mechanisms of FIG. 14 can be used to construct the two-dimensional drive fitting outline 800 of FIG. 8 in the same manner as in planar motor of FIG. 12.

A reference should be made here to the U.S. Pat. No. 5,345,137 to Funakubo et al. that describes a four-element crawling mechanism with a two-dimensional drive capability, similar to that of FIG. 14.

Another group of preferred embodiments, described below, is intended to add directional force feedback capability specifically to a mouse with a rolling ball, like one described in U.S. Pat. No. 3,987,685 to Opocensky. In this popular design, the rolling ball, captured in the mouse body, is used to translate horizontal X-Y movement of the mouse over the mouse pad into rotational movement of the ball and, further, into rotational movement of sensor rollers. In this group of the present invention embodiments the ball also serves as a part of a two-dimensional spherical motor that produces a directional torque. The torque further translates into horizontal propelling force when the ball has frictional contact with the mouse pad.

Two-dimensional spherical motors of different types have become popular with the development of robotics applications. Several such devices are described in U.S. Pat. No. 4,908,558 to Lordo et al., U.S. Pat. No. 4,983,875 to Masaki et al., U.S. Pat. No. 5,410,232 to Lee, U.S. Pat. No. 6,046,527 to Roopnarine et al., and others. However, none of the above mentioned examples in their original form provide features that satisfy particular application needs of the present invention. To supplement this, the preferred embodiments described below employ operational principle of motor drives of FIGS. 3 through 14 in combination with the mouse ball to devise spherical motors of the respective type.

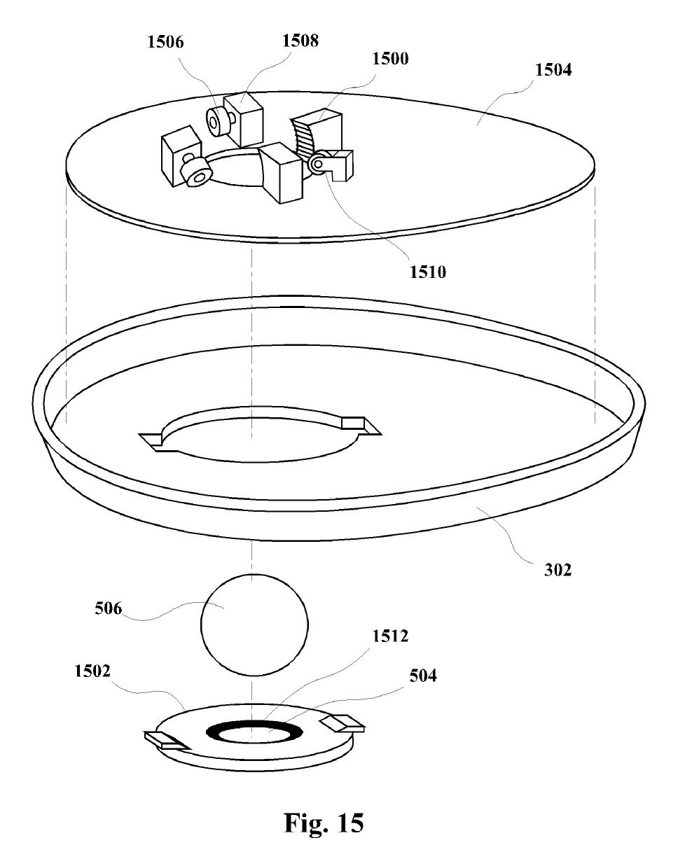

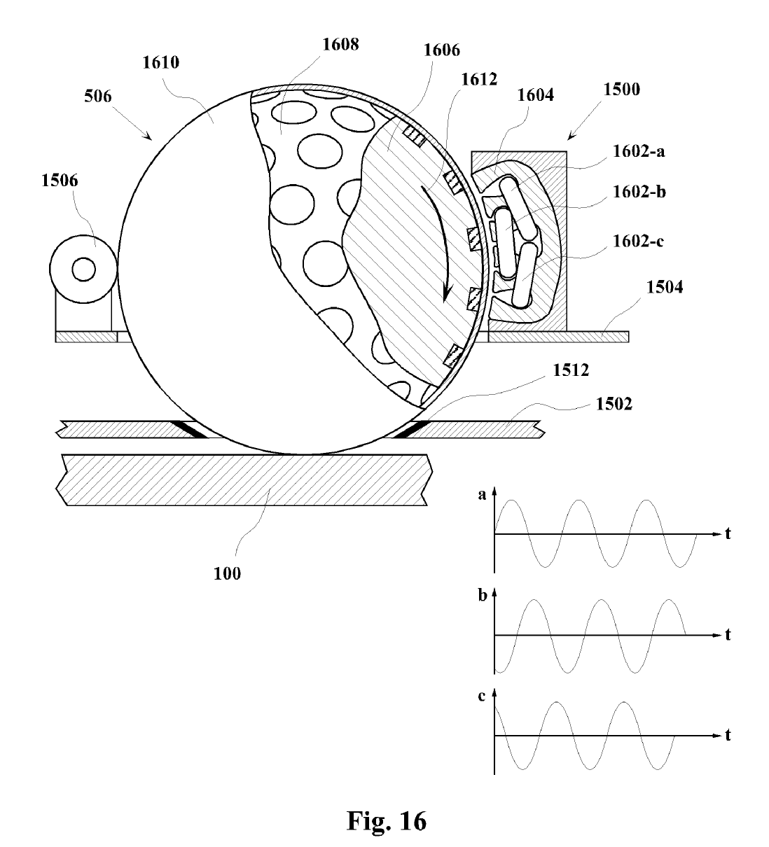

The eighth embodiment, illustrated in FIGS. 15 and 16, employs operational principle of asynchronous dynamoelectric motor of FIGS. 3 and 4 in a spherical motor wherein mouse ball 506 serves as a spherical rotor. FIG. 15 shows an assembly scheme of the device, where two stators 1500 of the spherical motor are mounted on a circuit board 1504 opposite of two mutually orthogonal X and Y position encoders 1508. Circuit board has an opening for mouse ball 506 and also carries a spring-loaded compression roller 1510, the control circuit, and other components that are not shown in the drawing for clarity. Mouse ball 506 is assembled from the bottom and captured in the device by a lock cover 1502. After assembly, ball 506 is forced against encoder rollers 1506 by compression roller 1510 and can extend through aperture 504 in lock cover 1502. Aperture 504 has a rubber collar 1512 on the inner side.

FIG. 16 shows a partial cross-section of the spherical motor of FIG. 15 that reveals the inner structure of mouse ball 506 and one stator 1500. Each stator 1500 has multiple coils 1602 and a ferromagnetic stator core 1604 with multiple poles, distributed in meridional direction. Mouse ball 506 has a ferromagnetic rotor core 1606 and an electrically conductive layer 1608. Rotor core 1606 can have multiple poles, protruding through conductive layer 1608 to form multiple short-circuit loops. Ball 506 is coated with a thin rubber layer 1610 that serves to provide sufficient traction with the mouse pad.

Operation of the spherical motor of FIGS. 15 and 16 is similar to that of the planar motor of FIGS. 3 and 4. The control circuit supplies phase-shifted alternating currents (a), (b), and (c) to coils 1602-a, 1602-b, and 1602-c of stator 1500. The alternating currents create magnetic flux in stator core 1604 that passes through its poles and closes through rotor core 1606, thereby creating induction currents in conductive layer 1608. Due to the phase shift, magnetic flux moves in meridional direction and produces electromotive torque 1612 when interacting with the induction currents in conductive layer 1608. The control circuit regulates amplitudes of alternating currents supplied to the coils in each of the mutually orthogonal stators to produce the sum torque in the desired direction. When the mouse is in working position, ball 506 is frictionally coupled with mouse pad 100 under its own weight, and the sum torque translates into propelling force. When the user lifts the mouse, ball 506 disengages from mouse pad 100 and comes to rest on rubber collar 1512 that prevents it from further rotation.

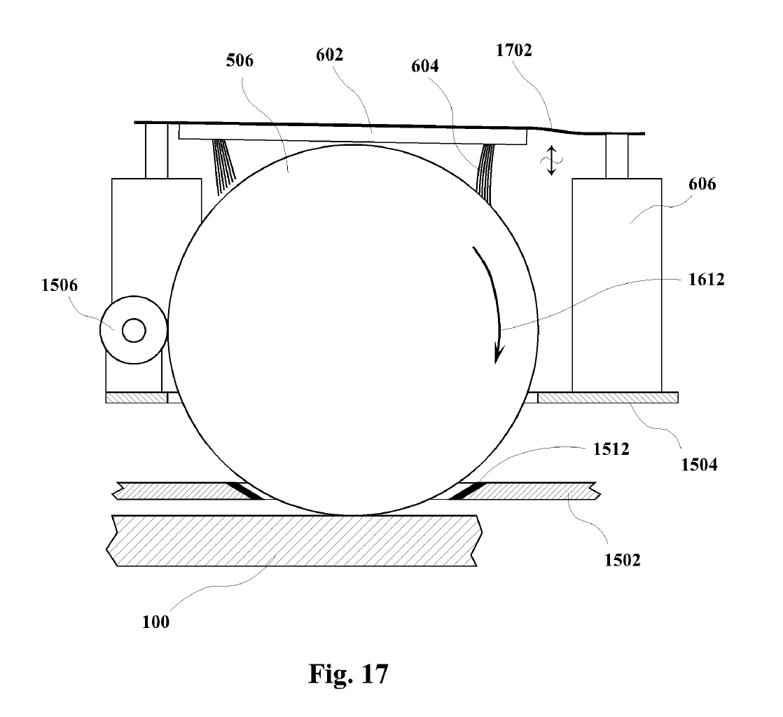

FIG. 17 shows a detailed sectional view of a vibrating brush spherical motor in the ninth embodiment of the present invention. The vibrating brush spherical motor assembly in the mouse body is similar to that of the dynamoelectric motor of FIG. 15, and its principle of operation is similar to that of the vibrating brush motor drive of FIG. 7. A circular brush 602 is suspended on a three-prong spring 1702 that is attached to the working ends of three actuators 606 mounted on circuit board 1504. Bristles 604 of circular brush 602 end in close proximity to mouse ball 506. The control circuit applies power to actuators 606 and causes brush 602 to vibrate with the maximum amplitude on the desired side. Vibrating bristles 604 strike the surface of mouse ball 506 on that side and produce torque 1612 in the desired direction. When the mouse is in working position, ball 506 has friction contact with mouse pad 100 under its own weight and torque 1612 translates into propelling force. When the user lifts the mouse, ball 506 disengages from mouse pad 100 and comes to rest on rubber collar 1512 that prevents it from further rotation, same as in spherical motor of FIGS. 15 and 16.

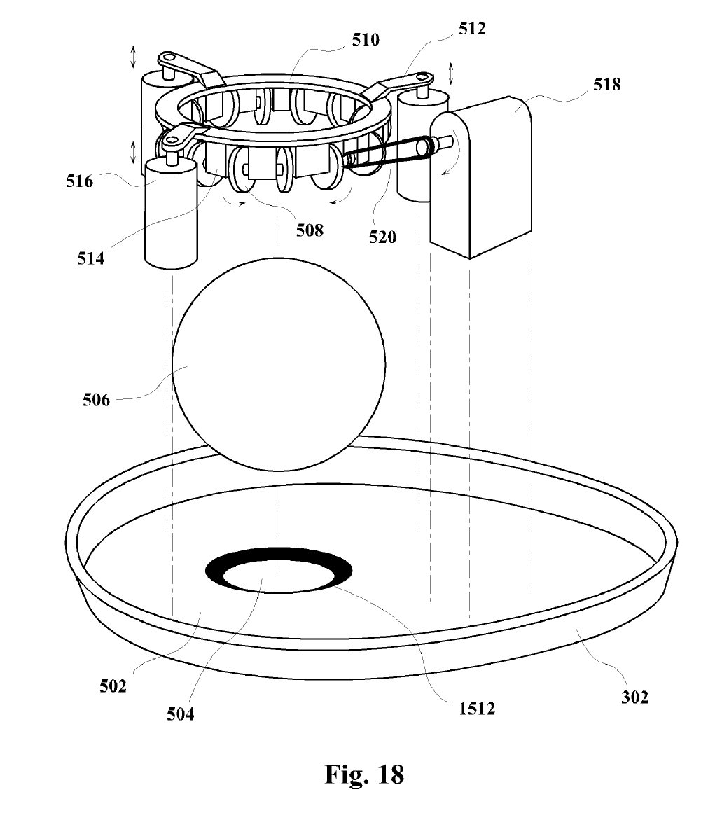

FIG. 18 shows the tenth embodiment of the present invention, wherein the spherical motor includes a plurality of friction wheels in an arrangement similar to that of FIG. 5. However, in this embodiment, ball 506 is used as a drive medium between the drive elements and the working surface. Same as in planar motor drive of FIG. 5, the control circuit differentially energizes actuators 516 such as to force down the side of frame 510 where friction wheels 508 rotate in the desired direction. The rotating wheels come in contact with ball 506 and rub on its surface, producing torque by friction. When the mouse is in working position, ball 506 has friction contact with the mouse pad under its own weight supplemented with additional force applied by actuators 516, and the torque translates into propelling force.

As it will be understood by those skilled in the art, the present invention may be embodied in other specific forms without departing from the essential characteristics thereof. For example, possible embodiments of the self-propelled mouse can employ other types of two-dimensional motor drive, use a different number of drive elements in various arrangements, or the described self-propelled mouse system can be used in applications other than a computer interface. It is therefore intended that the following claims include alterations, permutations, and equivalents, as they fall within the true spirit and scope of the present invention.

What is claimed is:

1. A mouse device for providing haptic feedback to a user, said mouse device comprising:
a substantially grounded support base having a substantially horizontal top working surface;
a mouse object moveable over said working surface and separable from said support base; and
a propulsion means secured in said mouse object and arranged such as to interact with said support base substantially on contact, said propulsion means operative to receive an input signal and to produce a substantially directional propelling force by interaction with said support base, varying magnitude and horizontal direction of said propelling force in response to said input signal,
whereby said user can move the mouse over said working surface and percept said propelling force as haptic feedback, while direction and magnitude of said propelling force being controlled by said input signal as desired in a particular application, and also said user can lift the mouse and carry it to a new position unimpeded.

2. The mouse device of claim 1 further including a sensor means secured in said mouse object and arranged such as to interact with said support base substantially on contact, said sensor means operative to detect a planar movement of the mouse over said working surface by interaction with said support base and to output a signal indicative of said planar movement.

3. The mouse device of claim 1 wherein said mouse object has a substantially flat bottom surface, said propulsion means comprise a plurality of drive members and a control means coupled therewith, said drive members geometrically arranged in two dimensions about said bottom surface, said drive members operative to interact with said support base and produce said propelling force in a direction predetermined by their geometrical arrangement when activated in a predetermined pattern, and said control means operative to activate said drive members and to modify said activation pattern such as to change direction and magnitude of said propelling force in response to said input signal.

4. The mouse device of claim 3 further including a sensor means secured in said mouse object and arranged such as to interact with said support base substantially on contact, said sensor means operative to detect a planar movement of the mouse over said working surface by interaction with said support base and to output a signal indicative of said planar movement.

5. The mouse device of claim 3 wherein said propulsion means is an asynchronous dynamoelectric planar motor comprising a ferromagnetic stator core, said stator core having an array of poles distributed in two dimensions about said bottom side of said mouse object, said drive members are electric coils wound around said poles, said control means comprise a control circuit activating said electric coils with alternating currents having phase difference dependent on a desired direction of said propelling force relative to the coils geometric location, said activation pattern comprises the distribution of individual amplitudes and phases between said electric coils, and said support base further comprises a ferromagnetic layer and a closed loop armature embedded therein,
whereby said alternating currents in the stator coils create a magnetic field passing through said stator core and moving across said array of poles, said moving magnetic field passes into said ferromagnetic layer and excites induction currents in said closed loop armature, and said induction currents magnetically interact with said moving magnetic field, thus producing said propelling force.

6. The mouse device of claim 3 wherein said drive members are friction wheels rotatably mounted in their bearings arranged to be horizontally restricted and vertically moveable in said mouse object such as said friction wheels can extend beyond said bottom surface, said friction wheels spatially distributed and diversely oriented in a horizontal plane, said control means comprising a control circuit and a set of actuators secured in said mouse object, connected to said control circuit, and mechanically coupled to said wheel bearings, said propulsion means further including a rotary motor rotationally coupled to said friction wheels,
wherein said rotary motor is operative to continuously rotate said friction wheels in a predetermined direction, said control circuit is operative to differentially energize said actuators in response to said input signal such as said actuators apply substantially vertical and dissimilarly distributed forces on said wheel bearings, thus activating said friction wheels by moving them down to extend beyond said bottom surface, and said activation pattern is the distribution of said vertical forces between said friction wheels.

7. The mouse device of claim 3 wherein said drive members are bristles secured in a brush arrangement, said bristles slanted from vertical in a direction substantially uniform within a close neighbourhood and varying between different neighbourhoods of said brush arrangement, said control means comprising a control circuit and a set of vibration actuators connected thereto and secured in said mouse object, said brush arrangement coupled to said vibration actuators such as to enable said bristles to vibrate and positioned in said mouse object such as to enable said vibrating bristles to strike beyond said bottom surface,
wherein said control circuit is operative to differentially energize said vibration actuators in response to said input signal such as vibration power is dissimilarly distributed between different neighbourhoods of said bristles and said activation pattern is the distribution of said vibration power within said brush arrangement,
whereby said control circuit modifies said activation pattern in a manner that said bristles slanted predominantly in a desired direction vibrate with maximum amplitude and repetitively strike against said working surface when the mouse is placed thereupon, thus producing said propelling force.

8. The mouse device of claim 3 wherein said propulsion means is a travelling wave planar motor further including an elastic layer, said drive members are piezoelectric elements arranged in a two-dimensional array and coupled to one side of said elastic layer, the other side of said elastic layer substantially aligned with said bottom surface of said mouse object and exposed therefrom, said control means comprise a control circuit operative to activate said piezoelectric elements with alternating voltages having individually distributed phases, and said activation pattern comprises the distribution of phases of said alternating voltages between said piezoelectric elements,
whereby said control circuit modifies said phase distribution in response to said input signal such as to produce travelling waves propagating along said elastic layer in a desired direction across said two-dimensional array, wavefront zones of said elastic layer cyclically move in a vertical plane by a circular trajectory and thus produce said propelling force by friction when said exposed elastic layer is brought in contact with said working surface.

9. The mouse device of claim 3 wherein said propulsion means further includes a plurality of friction members, said drive members are piezoelectric elements, every said friction member attached to a pair of said piezoelectric elements and having a vertex point substantially aligned with said bottom surface of said mouse object and exposed therefrom, said pairs diversely oriented in a horizontal plane, said control means comprising a control circuit operative to activate a selected group of said piezoelectric elements with alternating voltages having a phase difference within each respective pair, and said activation pattern characterized by said group selection and the elements order assignment within each respective pair,
whereby said control circuit selects a group of said piezoelectric element pairs oriented predominantly collinear to the desired propelling force direction and activates said selected group such as said vertex points of said friction members cyclically move by closed loop trajectories predominantly in one direction in a vertical plane, thus producing said propelling force by friction when the mouse is placed upon said working surface.

10. The mouse device of claim 3 wherein said drive members are piezoelectric elements, said propulsion means further includes at least one two-dimensionally driving crawling mechanism comprising a friction member and a group of said piezoelectric elements assembled in a predetermined geometric arrangement, said friction member having a vertex point substantially aligned with said bottom surface of said mouse object and exposed therefrom, said control means comprising a control circuit operative to activate said piezoelectric elements with alternating voltages having amplitudes and phases dissimilarly distributed between the elements of said group such as to cyclically move said vertex point by a closed loop trajectory in a vertical plane, thus enabling said crawling mechanism to drive in a desired direction in response to said input signal, wherein said activation pattern is the distribution of said alternating voltages amplitudes and phases between the elements of said group.

11. The mouse device of claim 10 wherein said group comprises three said piezoelectric elements distributed in two dimensions in a horizontal plane and secured in said mouse object, and said friction member is attached to three working ends thereof.

12. The mouse device of claim 10 wherein said group comprises four said piezoelectric elements, said friction member is attached to a first pair of said piezoelectric elements arranged side by side, said first pair is stacked mutually orthogonally upon a second pair of said piezoelectric elements arranged side by side, and said second pair is secured in said mouse object.

13. The mouse device of claim 1 wherein said mouse object has an aperture in a bottom side thereof, said propulsion means further including a ball horizontally restricted in said mouse object and exposed through said aperture such as to have a contact point with said working surface when the mouse is placed thereupon, said ball having at least two rotational degrees of freedom about its horizontal axes,
wherein said propulsion means is operative to impart a torque on said ball about said horizontal axes, thus interacting with said support base through said ball by friction at said contact point, whereby said torque translates into said horizontal propelling force.

14. The mouse device of claim 13 further including a sensor means secured in said mouse object and coupled to said ball, said sensor means operative to detect rotation of said ball and to output a signal indicative of said ball rotation about its two mutually orthogonal horizontal axes.

15. The mouse device of claim 13 wherein said propulsion means further comprise a plurality of drive members and a control means coupled therewith, said drive members geometrically arranged in two dimensions relative to said ball, said drive members operative to interact with said ball and impart said torque thereon in a direction predetermined by their geometrical arrangement when activated in a predetermined pattern, and said control means operative to activate said drive members and to modify said activation pattern such as to change direction and magnitude of said torque in response to said input signal.

16. The mouse device of claim 15 further including a sensor means secured in said mouse object and coupled to said ball, said sensor means operative to detect rotation of said ball and to output a signal indicative of said ball rotation about its two mutually orthogonal horizontal axes.

17. The mouse device of claim 15 wherein said propulsion means is an asynchronous dynamoelectric spherical motor having a rotor element and a stator element, said ball is said rotor element comprising a ferromagnetic rotor core and a closed loop armature embedded therein, said stator element having a ferromagnetic stator core with a plurality of stator poles distributed in two dimensions on a spherical surface conforming with a gap to said ball surface, said drive members are electric coils wound around said stator poles, said control means comprise a control circuit activating said electric coils with alternating currents having phase difference dependent on a desired direction of said torque relative to the coils geometric location, said activation pattern comprises the distribution of individual amplitudes and phases between said electric coils,
whereby said alternating currents in the stator coils create a magnetic field passing through said stator core and moving across said stator poles, said moving magnetic field passes through said gap into said ferromagnetic rotor core and excites induction currents in said closed loop armature, and said induction currents magnetically interact with said moving magnetic field, thus producing said torque.

18. The mouse device of claim 15 wherein said drive members are bristles secured in a brush arrangement, said bristles meridionally slanted and distributed around said ball by longitude with their ends positioned in close proximity to said ball surface, said control means comprising a control circuit and a set of vibration actuators connected thereto and secured in said mouse object, said brush arrangement coupled to said vibration actuators such as to enable said bristles to vibrate transversely to said ball surface,
wherein said control circuit is operative to differentially energize said vibration actuators in response to said input signal such as said bristles located about a desired longitude vibrate with maximum amplitude and strike said ball surface, thus producing a meridional torque, and said activation pattern is the distribution of the vibration energy between said bristles by their longitude.

19. The mouse device of claim 15 wherein said drive members are friction wheels rotatably mounted in their bearings in close proximity to said ball, said wheel bearings arranged to be tangentially restricted and transversely moveable such as said friction wheels can contact said ball surface, said friction wheels spatially distributed and diversely oriented in a horizontal plane, said control means comprising a control circuit and a set of actuators secured in said mouse object, connected to said control circuit, and mechanically coupled to said wheel bearings, said propulsion means further including a rotary motor rotationally coupled to said friction wheels,
wherein said rotary motor is operative to continuously rotate said friction wheels in a predetermined direction, said control circuit is operative to differentially energize said actuators in response to said input signal such as said actuators apply substantially transversal and dissimilarly distributed forces on said wheel bearings, thus activating said friction wheels by pressing them against said ball surface, and said activation pattern is the distribution of said transversal forces between said friction wheels.
